(19) United States
(12) Patent Application Publication
(10) Pub. No.: US 2012/0104925 A1
(43) Pub. Date: May 3, 2012

(54) SHELF ASSEMBLY PARTICULARLY SUITED FOR USE IN A REFRIGERATION APPLIANCE

(75) Inventors: Jonathan Ian Nash, La Grange, KY (US); Donald Joseph Breit, Louisville, KY (US)

(73) Assignee: GENERAL ELECTRIC COMPANY, Schenectady, NY (US)

(21) Appl. No.: 12/912,966

(22) Filed: Oct. 27, 2010

(51) Int. Cl. F25D 25/02; B23P 17/04

(52) U.S. Cl. 312/408; 29/428

(57) ABSTRACT

A shelf assembly is provided that is particularly suited for use in a refrigeration appliance. The shelf assembly includes a pane having edges that define a perimeter around the pane. A single-piece frame structure is fitted around the perimeter of the pane. The frame structure includes a unitary upper frame member having a flange portion extending inwardly from the pane edges and sealed against a top surface of the pane. A unitary lower frame member is connected to the upper frame member along a hinge line such that the upper and lower frame members are closed on each other with the pane seated between opposed flange portions of the frame members. An attachment mechanism is configured between the upper and lower frame members outward of the pane edges.

### FIELD OF THE INVENTION

The present subject matter relates generally to a shelf configuration, and more particularly to a spill-proof refrigerator shelf.

### BACKGROUND OF THE INVENTION

A refrigerator typically includes a number of shelves for the storage of food and beverage containers of many shapes and sizes. As the containers are retrieved, returned and/or rearranged on the shelves, occasional leaks and spilling of food and liquid may occur. Cleaning up after a spill on a crowded refrigerator shelf can be difficult, especially when spilled liquid leaks onto lower shelves.

To contain liquid spills on a refrigerator shelf, it is known to use “picture frame” shelves that include edges wrapped around, attached, or otherwise fitted to a glass plate to form a dam around the edges of the plate for containing spilled liquid. Reference is made, for example to U.S. Pat. No. 5,677,030, which describes a continuous edge trim that wraps around the peripheral edge of a glass shelf and extends above the glass to form a spill-proof dam. The trim piece has a substantially “F” shaped cross-sectional profile, with the glass sliding into the “U” chamber defined by the upper and lower arms. U.S. Pat. Nos. 5,429,433; 5,524,981; and 5,403,084 describe a refrigerator shelf having a rim directly molded around the entire perimeter edge of the shelf member. Frame assemblies are also known that include separate upper and lower frame members, with the glass shelf sandwiched between the frame members.

The conventional picture frame shelf assemblies have certain disadvantages from a production and/or cost perspective, or in terms of performance. For example, the insert molding (glass encapsulation) processes may depend on shrinkage of the plastic used to fabricate the frame, which requires the edges of the glass plate to be notched for the frame to properly seal the glass. The frames formed from separate frame members require multiple tools to form the frame members.

Accordingly, it would be desirable to provide a spill-proof shelf assembly that is reliable, is not dependent on variances between the glass shelf dimensions and/or shrinkage of the frame members, and is commercially feasible to produce.

### BRIEF DESCRIPTION OF THE INVENTION

Aspects and advantages of the invention will be set forth in part in the following description, or may be obvious from the description, or may be learned through practice of the invention.

In an exemplary embodiment, a shelf assembly is provided that is particularly suited for use in a refrigeration appliance, such as a refrigerator, freezer, refrigerator/freezer combination, and so forth. The shelf assembly includes a pane having perimeter edges. The pane is encased in a single-piece frame structure fitted around the perimeter of the pane. The frame structure includes a unitary upper frame member having a flange portion that extends inwardly from the pane edges along a top surface of the pane. A unitary lower frame member is connected to the upper frame member along a hinge line such that the upper and lower frame members are closed on each other with the pane seated between the frame members. An attachment mechanism is configured between the upper and lower frame members outward of the pane edges such that the pane is essentially clamped between the upper frame member and the lower frame member around the perimeter of the pane.

In another exemplary embodiment, a method is provided for framing a pane in a frame member in formation of a spill-proof shelf that may be used in any manner of refrigeration appliance. The method includes providing a unitary picture-frame structure having an upper frame member and a lower frame member hinged together along a hinge line in an open clamshell configuration. A pane is seated in one of the frame members, and the frame members are subsequently closed together onto the pane and secured together around the perimeter of the pane. In this manner, the pane is essentially clamped between the upper and lower frame members around the perimeter of the pane. The upper frame member includes a flange portion that extends inwardly from the edges of the pane and seals along a top surface of the pane.

These and other features, aspects and advantages of the present invention will become better understood with reference to the following description and appended claims. The accompanying drawings, which are incorporated in and constitute a part of this specification, illustrate embodiments of the invention and, together with the description, serve to explain the principles of the invention.

### BRIEF DESCRIPTION OF THE DRAWINGS

A full and enabling disclosure of the present invention, including the best mode thereof, directed to one of ordinary skill in the art, is set forth in the specification, which makes reference to the appended figures, in which:

FIG. 1 is a perspective view of a refrigeration appliance, in particular a refrigerator, incorporating one or more shelf assemblies in accordance with aspects of the invention;

FIG. 2 is a perspective view of an embodiment of a clamshell frame structure in an open configuration;

FIG. 3 is a cross-sectional view through the back side of a shelf assembly having the frame structure of FIG. 2;

FIG. 4 is a cross-sectional view through one of the sides of a shelf assembly having the frame structure of FIG. 2;

FIG. 5 is a cross-sectional view through the front side of a shelf assembly having the frame structure of FIG. 2;

FIG. 6 is a cross-sectional view through a different location along the front side of a shelf assembly having the frame structure of FIG. 2;

FIG. 7 is a perspective view of an alternate embodiment of a clamshell frame structure in an open configuration;

FIG. 8 is a cross-sectional view through the back side of a shelf assembly having the frame structure of FIG. 7;

FIG. 9 is a cross-sectional view through one of the sides of a shelf assembly having the frame structure of FIG. 7;

FIG. 10 is a cross-sectional view through the front side of a shelf assembly having the frame structure of FIG. 7;

FIG. 11 is a perspective view of a shelf assembly having the frame structure of FIG. 7; and

FIG. 12 is a side view of the shelf assembly of FIG. 11.

### DETAILED DESCRIPTION OF THE INVENTION

Reference now will be made in detail to embodiments of the invention, one or more examples of which are illustrated in the drawings. Each example is provided by way of explanation of the invention, not limitation of the invention. In fact, it will be apparent to those skilled in the art that various modifications and variations can be made in the present invention without departing from the scope or spirit of the invention. For instance, features illustrated or described as part of one embodiment can be used with another embodiment to yield a still further embodiment. Thus, it is intended that the present invention covers such modifications and variations as come within the scope of the appended claims and their equivalents.

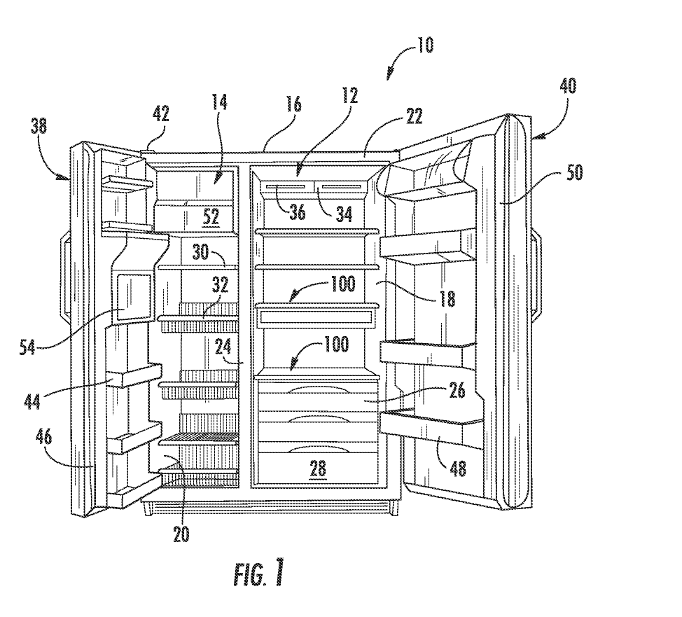

FIG. 1 is a perspective view of an exemplary refrigeration appliance 10 depicted as a refrigerator in which shelf assemblies 100 in accordance with aspects of the present invention may be utilized. It should be appreciated that the refrigeration appliance of FIG. 1 is for illustrative purposes only. The present invention is not limited to any particular type, style, or configuration of refrigeration appliance, and such appliance may include any manner of refrigerator, freezer, refrigerator/freezer combination, and so forth.

Referring to FIG. 1, the refrigerator 10 includes a fresh food storage compartment 12 and a freezer storage compartment 14, with the compartments arranged side-by-side and contained within an outer case 16 and inner liners 18 and 20 generally molded from a suitable plastic material. In smaller refrigerators 10, a single liner is formed and a mullion spans between opposite sides of the liner to divide it into a freezer storage compartment and a fresh food storage compartment. The outer case 16 is normally formed by folding a sheet of a suitable material, such as pre-painted steel, into an inverted U-shape to form top and side walls of the outer case 16. A bottom wall of the outer case 16 normally is formed separately and attached to the case side walls and to a bottom frame that provides support for refrigerator 10.

A breaker strip 22 extends between a case front flange and outer front edges of inner liners 18 and 20. The breaker strip 22 is formed from a suitable resilient material, such as an extruded acrylo-butadiene-styrene based material (commonly referred to as ABS). The insulation in the space between inner liners 18 and 20 is covered by another strip of suitable resilient material, which also commonly is referred to as a mullion 24 and may be formed of an extruded ABS material. Breaker strip 22 and mullion 24 form a front face, and extend completely around inner peripheral edges of the outer case 16 and vertically between inner liners 18 and 20.

Slide-out drawers 26 and a storage bin 28 are normally provided in fresh food storage compartment 12 to support items being stored therein, as well as one or more shelf assemblies 100 in accordance with the present invention. The shelf assemblies 100 are described in greater detail below. In addition, at least one shelf 30 and at least one wire basket 32 are also provided in freezer storage compartment 14.

The refrigerator features are controlled by a controller 34 according to user preference via manipulation of a control interface 36 mounted in an upper region of fresh food storage compartment 12 and coupled to the controller 34. As used herein, the term “controller” is not limited to just those integrated circuits referred to in the art as microprocessor, but broadly refers to computers, processors, microcontrollers, microcomputers, programmable logic controllers, application specific integrated circuits, and other programmable circuits, and these terms are used interchangeably herein. The controller 34 may also be an electromechanical device.

A freezer door 38 and a fresh food door 40 close access openings to freezer storage compartment 14 and fresh food storage compartment 12. Each door 38, 40 is mounted by a top hinge 42 and a bottom hinge (not shown) to rotate about its outer vertical edge between an open position, as shown in FIG. 1, and a closed position. The freezer door 38 may include a plurality of storage shelves 44 and a sealing gasket 46, and fresh food door 40 also includes a plurality of storage shelves 48 and a sealing gasket 50.

The freezer storage compartment 14 may include an automatic ice maker 52 and a dispenser 54, provided in the freezer door 38 such that ice and/or chilled water can be dispensed without opening the freezer door 38, as is well known in the art.

As with known refrigerators, the refrigerator 10 also includes a machinery compartment (not shown) that at least partially contains components for executing a known vapor compression cycle for cooling air. The components include a compressor, a condenser, an expansion device, and an evaporator connected in series and charged with a refrigerant. The evaporator is a type of heat exchanger which transfers heat from air passing over the evaporator to the refrigerant flowing through the evaporator, thereby causing the refrigerant to vaporize. The cooled air is used to refrigerate one or more refrigerator or freezer compartments via fans. Collectively, the vapor compression cycle components in a refrigeration circuit, associated fans, and associated compartments are conventionally referred to as a sealed system. The construction and operation of the sealed system are well known to those skilled in the art.

FIGS. 2 through 6 depict an embodiment of a shelf assembly 100 that may be used in the refrigerator 10 depicted in FIG. 1, or in any other type of refrigeration appliance. Although the shelf assembly 100 is particularly suited for use in a refrigeration appliance, it should be appreciated that the shelf assembly 100 is not limited to such use and may have utility in any type of storage device or compartment wherein a spill-proof shelf having the attributes of the present invention is desired. The shelf assembly 100 includes a pane 102, which is typically formed from glass or any other suitable material, such as a clear plastic material. The pane 102 has edges 104 that define a perimeter of the pane 102. The pane 102 includes a top surface 110 and a bottom surface 112.

The shelf assembly 100 includes a single-piece clamshell frame structure 114 that sandwiches the pane 102 between a unitary upper frame member 116 and a unitary lower frame member 126. The frame structure 114 is “single-piece” in that it does not comprise multiple components that are assembled or separately fitted together around the pane 102, but is a single unitary member having frame members 116, 126 connected along a hinge line 130, as described in greater detail below.

In a particular embodiment, the frame structure 114 is molded from a plastic material having characteristics suitable for use in the environment of the shelf assembly 100. For example, the frame structure 114 may be fabricated from a talc-filled polypropylene, acrylonitrile-butadine-styrene (ABS), or high-impact polystyrene (HIPS). Other suitable materials may also be used.

The single-piece frame structure 114 may be formed from separate frame members 116, 126 that are subsequently joined along the hinge line 130, for example in a ultra-sonic welding process or other suitable joining process.

The upper frame member 116 has a “picture frame” configuration and includes a flange portion 120 that extends inwardly from edges 104 along the top surface 110 of the pane 102. The flange 120 may terminate at an end that creates a dam 122 to fluids that may be spilled onto the top surface 110. Other portions of the upper frame member 116 extend outwardly beyond the edges 104. Along the back of the frame structure 114, the upper frame member may define a raised lip 160 as an additional dam to spills.

The unitary lower frame member 126 also has a picture frame configuration and is pivotally configured with the upper frame member 116 at the hinge line 130. The lower frame member 126 includes a wall 128 upon which the pane 102 is supported. The wall 128 may include a flange or any other type of structure for providing an increased surface area footprint for the pane 102. Other portions of the lower frame member 126 extend outwardly beyond the edges 104 of the pane 102. As particularly seen in FIGS. 2 through 6, the pane 102 is pressed between the flange 120 of the upper frame member 116 and the wall 128 upon the frame members 116, 126 being closed on each other.

A suitable attachment mechanism 138 is configured between the lower frame member 126 and the upper frame member 116 around at least a portion of the perimeter of the pane 102. The attachment mechanism 138 is configured between the portions of the frame members 116, 126 that extend outward beyond the pane edges 104. In the particular embodiment illustrated in FIGS. 2 through 6, the attachment mechanism 138 is defined by a male member configured on one of the frame members that engages with a female member configured on the other respective frame member. For example, the male component of the attachment mechanism 138 is defined by the tabs 144 that are spaced around the underside of the upper frame member 126. The female component is defined by the corresponding slots 146 defined in the lower frame member 126 by the spaced slot structures 145. When the frame members 116, 126 are folded onto each other along the hinge line 130, the tabs 144 engage through the slots 146, as particularly illustrated in FIGS. 4 through 6.

In the embodiment of FIGS. 2 through 6, the tabs 144 are resilient and include a snap head 147 that initially slides against projections 149 that define the opening to slots 146. Once the head 147 passes over the projection 149, the tab 144 straightens and the head 147 snaps into a locked position under the projection. Various other types of snap-fit connections may be utilized in this regard, including for example a bayonet-type fastener, and the like.

In an alternate embodiment illustrated for example in FIGS. 8 through 10, the ends of the tabs 144 that extend through the slots 146 may be deformed into caps 148, for example in a heat-stake process, that prevents the tab 144 from pulling out from the slot 146. Alternatively, any other suitable means may be utilized to ensure that the tabs 144 do not pull out from the slots 146.

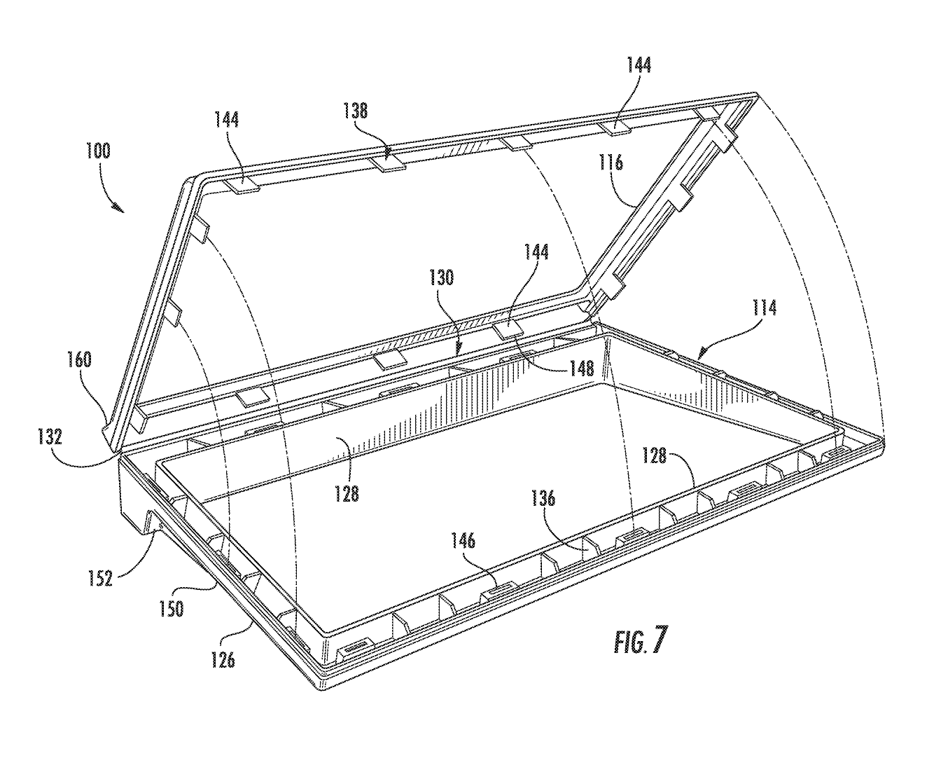

In the embodiment of FIG. 2, a plurality of the tabs 144 and slots 146 are spaced around the sides and front of the frame members 116, 126. The devices may not be required along the back of the frame members adjacent to the hinge line 130. On the other hand, in the embodiment of FIG. 7, the tabs 144 and slots 146 are also provided along the back side of the frame members 116, 126 for additional security.

In a particular embodiment illustrated in the figures, the hinge line 130 is defined by a living hinge 132 that connects the lower frame member 126 with the upper frame member 116. The living hinge 132 may be defined by a thinned or weakened area of the molded plastic material along the hinge line 130. In an alternate embodiment, the living hinge 132 may be defined by a flexible strip of material that is co-molded with the frame members 116, 126 along the hinge line 130.

Desirably, a gasket material 134 is sandwiched between the top surface 110 of the pane 102 and the flange 120 of the upper frame member 116. The gasket material 134 may be a strip of compressible sealing material that is applied on the top surface 110 prior to installation of the frame structure 114 around the pane 102. In the embodiment of FIGS. 2 through 6, the gasket material 134 is a strip of material that is an integral component of the upper frame member 116. For example, the gasket material 134 may be co-molded with the flange 120. In an alternative embodiment, the gasket material 134 may be pre-applied to the pane 102, for example in a hot-stamping process. The gasket material 134 may be a bead of material, such as silicon, that is applied to the pane 102 or upper frame member 116. It should also be appreciated that the invention is not limited to any particular type of gasket material 134. TPE (Thermoplastic Elastomer) and TPO (Thermoplastic Polyolefin) are suitable materials, as well as a number of other moldable resilient materials. Compression or performance of the gasket material 134 produces the spill-proof characteristic of the shelf assembly 100. “Spill-proof” is generally recognized in the art as the ability of the shelf to retain twelve oz. of fluid for at least twenty-four hours. Lesser performance is generally referred to as “spill-resistant.”

In alternative embodiments, the gasket material 134 may be replaced by, or augmented with, a hydrophobic coating applied around the perimeter of the pane 102.

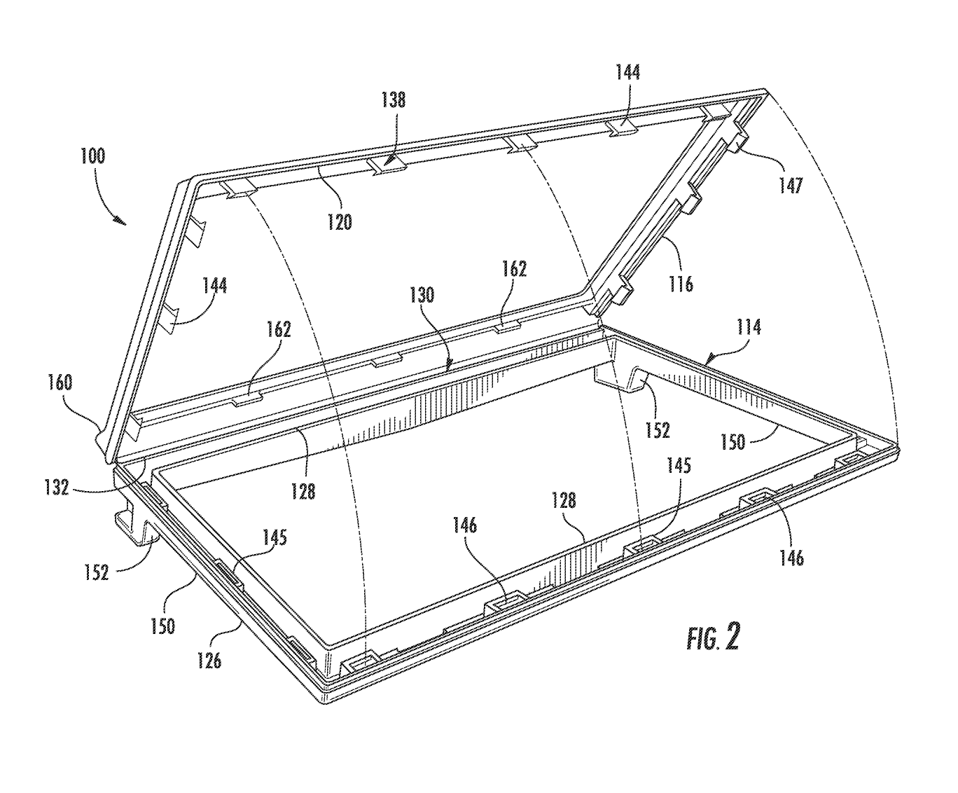

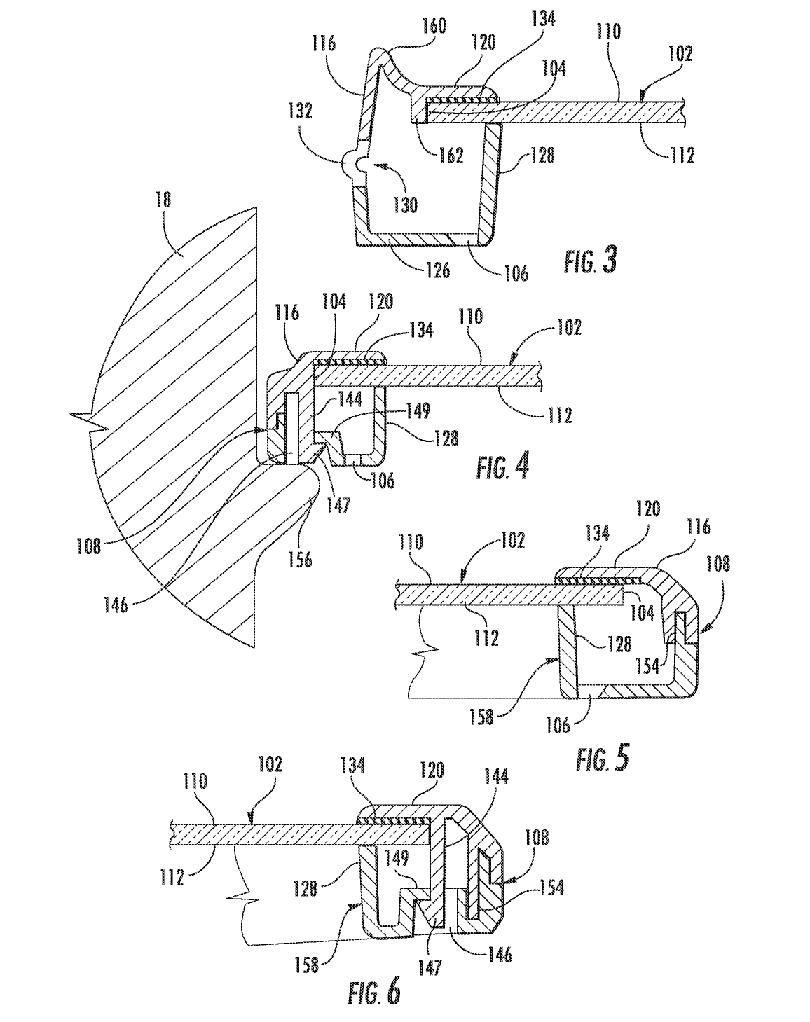

As particularly seen in FIG. 7, the lower frame member 126 may have a hollow shell configuration defined by the wall 128. One or more reinforcing ribs 136 may be provided within the lower frame member 126 to provide a desired degree of structural integrity to the frame structure 114 to ensure that the shelf assembly 100 can carry the designed load and be supported by brackets or other support structure within the appliance 10. In addition, drain holes 106 (FIGS. 3, 4, and 5) may be defined in the wall 128 along the bottom of the lower frame member 116 so that any liquid that may seep into the hollow shell can drain. Drain holes 106 of multiple shelf assemblies 100 may be linked by any manner of structure within the refrigerator so that the shelves all drain to a common disposal reservoir.

In order to positively seat the pane 102 within the frame structure 114 during construction of the shelf assembly 100, positioning shoulders may be provided around the perimeter of the frame structure 114. In FIGS. 2 and 3, locating tabs 162 are provided along the back edge of the upper frame member 126 for this purpose. The back edge 104 of the pane 102 is engaged against the locating tabs 162 during construction of the shelf assembly 100. Along the sides and front of the frame structure 114, the tabs 144 that function as components of the attachment mechanism 138 also serve as positioning shoulders for the pane 102, as seen in FIGS. 4 and 6.

A separation line 108 is defined at the interface of the upper and lower frame members 116, 126 around the sides and front of the frame structure 114. Any manner of interengaging structure between the frame members 116, 126 may be provided along the line 108. For example, FIGS. 4 through 6, 9, and 10 illustrate a notched configuration 154 along the separation line 108 wherein a tongue formed on one of the frame members engages in a groove formed in the opposing frame member.

In a unique embodiment, the shelf assembly 100 is configured as a pull-out shelf that can be slid into and out of the refrigerator 10 or other appliance. For this purpose, a pull-out handle 158 may be configured at the front edge of the frame structure 114. For example, in the illustrated embodiments, the handle 158 is defined by the portion of the lower frame member 116 that extends along the front of the frame structure 114. This portion has a depth that allows a user to place their fingers behind the wall 128 to grasp and pull the shelf assembly 100. In an alternate embodiment, a handle may be defined by molded extensions of the upper or lower frame members 116, 126.

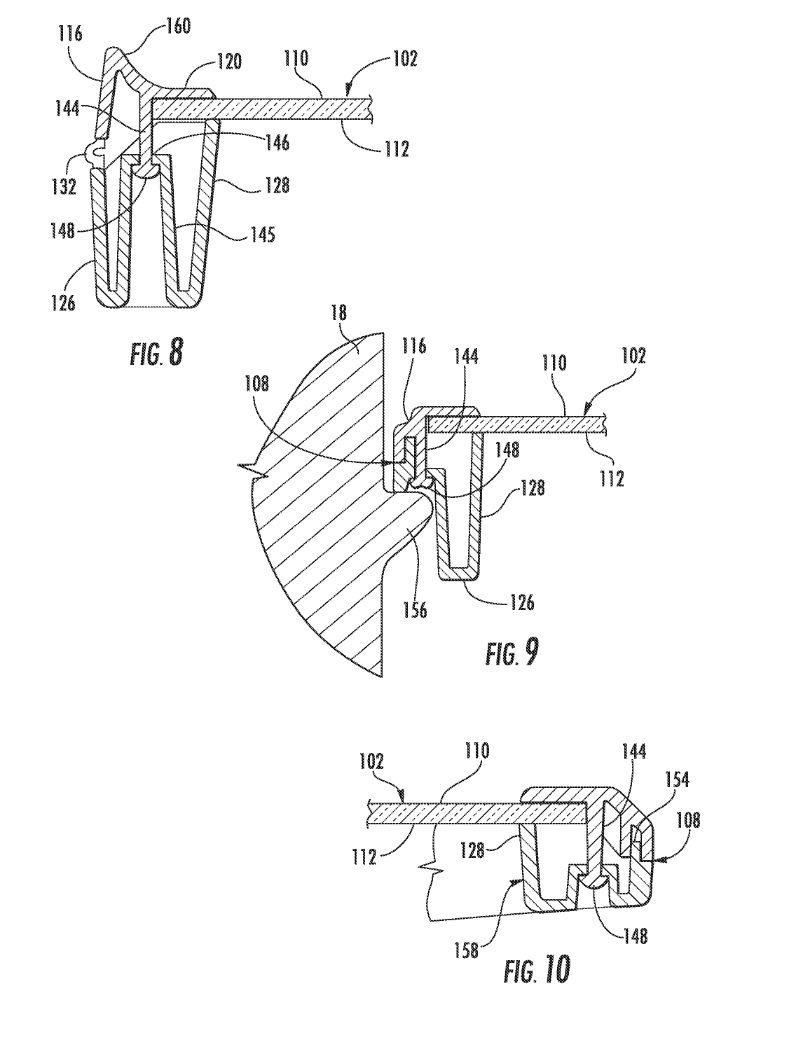

The frame structure 114 may further define a slide surface to facilitate movement of the shelf assembly 100 into and out of the refrigerator 10, for example along ledges 156 defined in the liners 18, 20, as depicted in FIGS. 4 and 9. In the embodiment of FIGS. 2 through 6, a slide surface 150 is defined by the underside of the lower frame structure 126 along the sides of the frame structure 114. A stop 152 is defined by the lower frame member 126 adjacent to the back edge of the frame structure 114. The stop 152 engages against an end of the ledge 156 (or other defined structure) in the refrigerator 10 to prevent inadvertent pulling of the shelf assembly 100 completely out of the refrigerator 10.

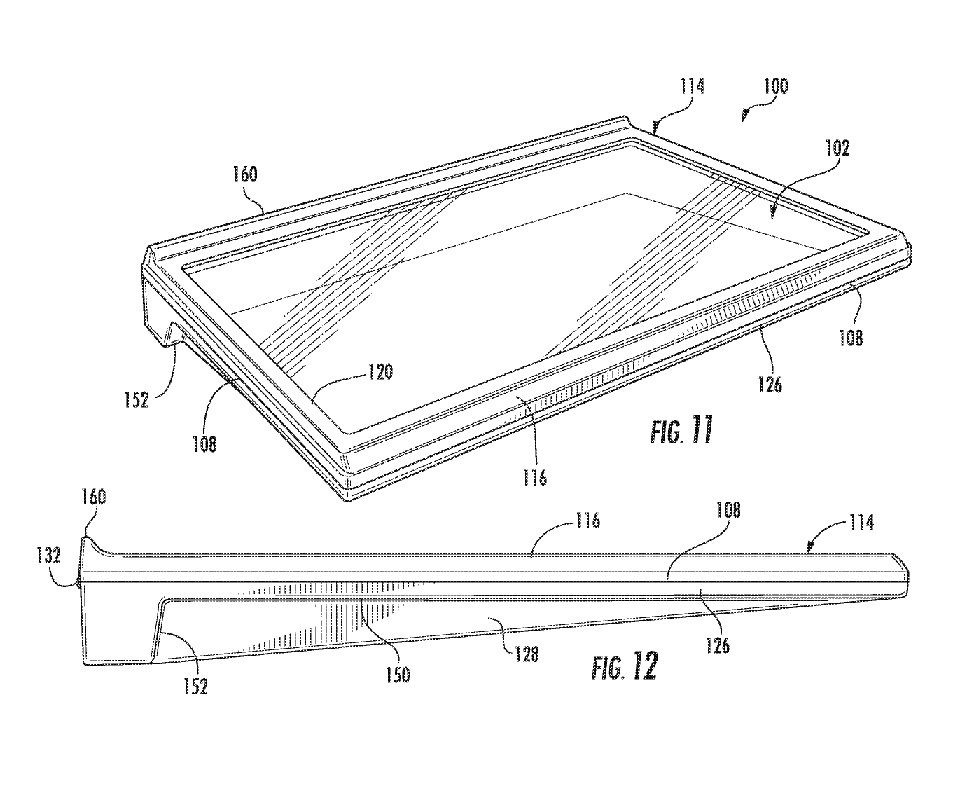

In the embodiment of FIGS. 7 through 12, the lower frame member 126 has a significantly greater depth (in the vertical direction as defined by the wall 128) as compared to the embodiment of FIGS. 2 through 6. This configuration adds increased structural strength and rigidity to the frame structure 114 overall, and may be desired for certain applications of the shelf assembly 100 designed for heavier loads. In this embodiment, the slide surfaces 150 and stops 152 are defined by an undercut region of the wall 128 along the sides of the frame structure 114, as particularly seen in FIGS. 11 and 12.

The present invention also encompasses various method embodiments for framing a pane 102 in a frame member in formation of a spill-proof shelf assembly 100. The method includes providing a unitary picture-frame structure 114 having an upper frame member 116 and a lower frame member 126 hinged together along a hinge line 130 in an open clamshell configuration. The pane 102 is seated in one of the upper or lower frame members 116, 126, for example within tabs 144, 162. The frame members are then closed on each other and secured together along a separation line such that the pane 102 is pressed between the frame members 116, 126. The upper frame member 116 has a flange portion 120 that seals against a top surface 110 of the pane 102. The method may include providing a gasket material 134 between the flange portion 120 and the top surface of the pane, for example by co-molding a strip of sealing material in the flange portion 120 during molding of the frame structure 114. The gasket material 134 could be pre-applied to the pane 102, for example in a hot-stamping process.

The method may further include aligning the upper and lower frame members 116, 126 with interengaging structure 144, 146 spaced around a perimeter of the upper and lower frame members, or with continuous structure 154 around the perimeter. The interengaging structure 144, 146 may also server to attach the upper and lower frame members 116, 126 together.

This written description uses examples to disclose the invention, including the best mode, and also to enable any person skilled in the art to practice the invention, including making and using any devices or systems and performing any incorporated methods. The patentable scope of the invention is defined by the claims, and may include other examples that occur to those skilled in the art. Such other examples are intended to be within the scope of the claims if they include structural elements that do not differ from the literal language of the claims, or if they include equivalent structural elements with insubstantial differences from the literal languages of the claims.

What is claimed is:

1. A shelf assembly particularly suited for use in a refrigeration appliance, comprising:
a pane having edges defining a perimeter of said pane;
a single-piece frame structure fitted around said perimeter of said pane;
said frame structure further comprising:
a unitary upper frame member having a flange portion extending inwardly from said pane edges and sealed against a top surface of said pane;
a unitary lower frame member connected to said upper frame member along a hinge line such that said upper frame member and said lower frame member are closed on each other with said pane seated between said upper and lower frame members; and
an attachment mechanism configured between said upper and lower frame member outward of said pane edges.

2. The shelf assembly as in claim 1, further comprising a living hinge formed between said lower frame member and said upper frame member along said hinge line.

3. The shelf assembly as in claim 1, further comprising a gasket material configured on an underside of said flange portion of said upper frame member that seals against said top surface of said pane.

4. The shelf assembly as in claim 3, wherein said unitary frame member is injection molded and said gasket material is co-molded with said upper frame member.

5. The shelf assembly as in claim 3, wherein said gasket material is pre-applied to said top surface of said pane.

6. The shelf assembly as in claim 1, further comprising a plurality of locating tabs defined around at least one of said upper or lower frame members, said locating tabs engaging said pane edges to position said pane within said frame structure.

7. The shelf assembly as in claim 6, wherein said locating tabs are a component of said attachment mechanism, said locating tabs extending through slots defined in the respective opposite one of said lower or upper frame members.

8. The shelf assembly as in claim 7, wherein said tabs are capped so as not to pull out of said slots.

9. The shelf assembly as in claim 7, wherein said tabs are snap-fitted into said slots.

10. The shelf assembly as in claim 1, wherein said attachment mechanism comprises a male/female interlocking configuration between said upper and lower frame members.

11. The shelf assembly as in claim 10, wherein said male/female interlocking configuration comprises a plurality of tabs extending from one of said upper or lower frame members and engaging in respective slots in the other of said lower or upper frame members.

12. The shelf assembly as in claim 11, wherein said tabs are capped or have a snap-fit head so as not to pull out of said slots.

13. The shelf assembly as in claim 1, wherein said shelf assembly is a pull-out shelf assembly, said lower frame member defining a pull-out handle along a front edge of said pane.

14. The shelf assembly as in claim 13, wherein said lower frame member defines a slide surface outward of said side edges of said pane.

15. The shelf assembly as in claim 1, further comprising a plurality of drain openings in said lower frame member.

16. The shelf assembly as in claim 15, wherein said drain openings are configured for draining to a common disposal reservoir.

17. A method for framing a pane in a frame member in formation of a spill-proof shelf, comprising:
providing a unitary picture-frame structure having an upper frame member and a lower frame member hinged together along a hinge line in an open clamshell configuration;
seating a pane in one of the upper or lower frame members; and
closing the upper and lower frame members onto the pane and securing the upper and lower frame members together, the upper frame member having a flange portion that extends inwardly from the edges of the pane and seals against a top surface of the pane.

18. The method as in claim 17, further comprising providing a gasket material between the flange portion and the top surface of the pane.

19. The method as in claim 17, further comprising aligning the upper and lower frame members with interengaging structure spaced around a perimeter of the upper and lower frame members.

20. The method as in claim 17, further comprising aligning the pane in the upper and lower frame members with a plurality of locating tabs spaced around a perimeter of at least one of the upper or lower frame members, and further comprising using the locating tabs to align and secure the upper and lower frame members together.
